(19) United States
(12) Patent Application Publication
(10) Pub. No.: US 2020/0293895 A1
(43) Pub. Date: Sep. 17, 2020

(54) INFORMATION PROCESSING METHOD AND APPARATUS

(71) Applicant: Toshiba Memory Corporation, Minato-ku (JP)

(72) Inventors: Fumihiko TACHIBANA, Yokohama (JP); Daisuke MIYASHITA, Kawasaki (JP)

(73) Assignee: Toshiba Memory Corporation, Minato-ku (JP)

(21) Appl. No.: 16/566,241

(22) Filed: Sep. 10, 2019

(30) Foreign Application Priority Data
Mar. 13, 2019 (JP) 2019-045838

(51) Int. Cl. G06N 3/08

(52) U.S. Cl. CPC G06N 3/084

(57) ABSTRACT

According to one embodiment, a method of a learning processing of a deep layer neural network having an intermediate layer including a convolution layer, in an information processing using a processor and a memory used for an operation of the processor, includes: acquiring a second value represented by the second number of bits obtained by reducing the first number of bits representing a first value being an input value in units of channel in the intermediate layer of the deep layer neural network; and storing the acquired second value of the second number of bits into the memory. The method further includes performing a back propagation using the second value stored in the memory instead of the first value.

### CROSS-REFERENCE TO RELATED APPLICATIONS

This application is based upon and claims the benefit of priority from the Japanese Patent Application No. 2019-filed Mar. 13, 2019, the entire contents of which are incorporated herein by reference.

### FIELD

Embodiments described herein relate generally to an information processing method and an information processing apparatus.

### BACKGROUND

A convolutional neural network (CNN) is, for example, a type of a deep neural network (DNN) that is effective for image recognition processing and applies back propagation of an error in a learning processing.

The CNN includes an input layer, an intermediate layer, and an output layer. The CNN receives an input value at the input layer, performs a series of processes using the input value and a parameter (weight) in the intermediate layer, and outputs calculated output value from the output layer. In the intermediate layer, input values (corresponding to output values of a previous stage layer) in a plurality of layers including a convolution layer are referred to as activation.

The activation is stored in the memory during the back propagation in the learning processing of the CNN. In this case, in order to save a memory capacity for storing the activation, a quantization is performed to reduce the number of bits of activation. Note that the quantization is not a process of converting a so-called analog value into a digital value, but means a process of reducing the number of original bits of a value representing activation.

Although the quantization of activation saves memory capacity, it is recognized that when the number of bits of activation is simply reduced, the accuracy of the learning processing of the CNN may be reduced.

### BRIEF DESCRIPTION OF THE DRAWINGS

FIG. 1 is a block diagram illustrating a configuration of a system according to a first embodiment;

FIG. 2 illustrates a block diagram of an example of a CNN in the first embodiment;

FIG. 3 is a diagram for explaining convolution processing and quantization included in a learning processing in the first embodiment;

FIG. 4 is a flowchart for explaining a procedure of the learning processing according to the first embodiment;

FIG. 5 is a diagram for explaining an example of an effect according to the first embodiment;

FIG. 6 is a block diagram illustrating an example of a schematic configuration of a learning processing unit according to a second embodiment;

FIG. 7 is a flowchart for explaining a procedure of the learning processing according to the second embodiment;

FIG. 8 is a diagram for explaining an example of an effect in the second embodiment; and

FIG. 9 is a diagram for explaining a configuration of a modification of the second embodiment.

### DETAILED DESCRIPTION

According to one embodiment, a method of a learning processing of a deep layer neural network having an intermediate layer including a convolution layer, in an information processing using a processor and a memory used for an operation of the processor, includes: acquiring a second value represented by the second number of bits obtained by reducing the first number of bits representing a first value being an input value in units of channel in the intermediate layer of the deep layer neural network; and storing the acquired second value of the second number of bits into the memory. The method further includes performing a back propagation using the second value stored in the memory instead of the first value.

Various embodiments will be described hereinafter with reference to the accompanying drawings.

### First Embodiment

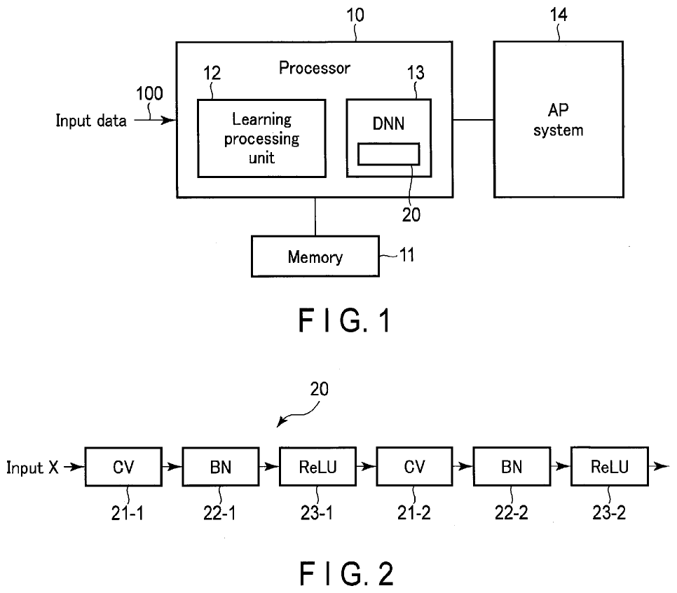

FIG. 1 is a block diagram illustrating a configuration of a system according to a first embodiment. As illustrated in FIG. 1, the system of the first embodiment includes a processor 10, a memory 11, and an application (AP) system 14.

The processor 10 is, for example, a graphic processing unit (GPU) or a central processing unit (CPU), and is configured by hardware and software. The processor 10 performs a learning processing using the memory 11 on a deep neural network (referred to as a DNN or simply a neural network) 13 by a learning processing unit 12 that is software. The learning processing unit 12 includes a quantization unit that performs quantization to be described later.

In the first embodiment, for example, a convolutional neural network (CNN) 20 effective for image recognition processing as the DNN 13 will be explained. That is, the processor 10 performs a learning processing of parameters of the CNN 20 related to an image recognition by using input data 100 including, for example, 60,000 image data sets as learning data (or training data). Note that the input data 100 also includes a correct answer label (supervised data) for comparison with output of the CNN.

The AP system 14 is an image recognition system that uses the CNN 20 optimized by the processor 10 and recognizes, for example, an unknown input image. The image recognition system includes a computer, a server system, or a cloud system that performs a web service which are configured by hardware and software.

FIG. 2 is a block diagram illustrating an example of the CNN 20 applied to the present embodiment. As illustrated in FIG. 2, the CNN 20 includes the intermediate layer between an input layer (not illustrated) and an output layer (not illustrated). The intermediate layer is also referred to as a hidden layer.

The intermediate layer has a multi-stage layer structure including a first stage layer including a convolution layer (hereinafter a CV layer) 21-1, a batch-normalization layer (BN layer) 22-1, and an activation layer 23-1, and a second stage layer including a CV layer 21-2, a BN layer 22-2, and an activation layer 23-2.

In the first embodiment, the CNN 20 causes the learning processing unit 12 to perform a learning processing (mini batch learning processing) on input data (input X) having a mini batch size divided from the input data 100.

In the CNN 20, the CV layer 21-1 (21-2) performs convolution processing on the input X. The BN layer 22-1 (22-2) performs normalization and affine transformation.

That is, the BN layer 22-1 (22-2) adjusts a distribution of features calculated by the CV layer 21-1 (21-2), performs normalization processing to eliminate the bias of the distribution, and performs scale and shift processing by the affine transformation. The activation layer 23-1 (23-2) performs activation (numerical value conversion processing) using, for example, a rectified linear unit (ReLU) of an activation function.

### Operation of First Embodiment

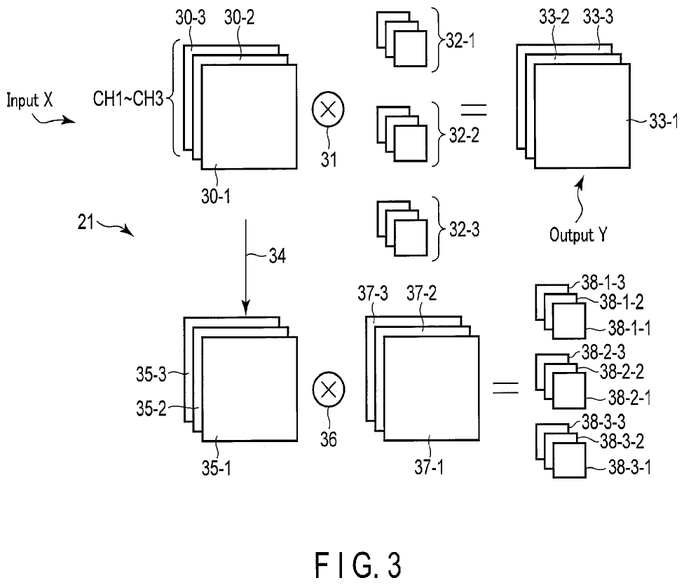

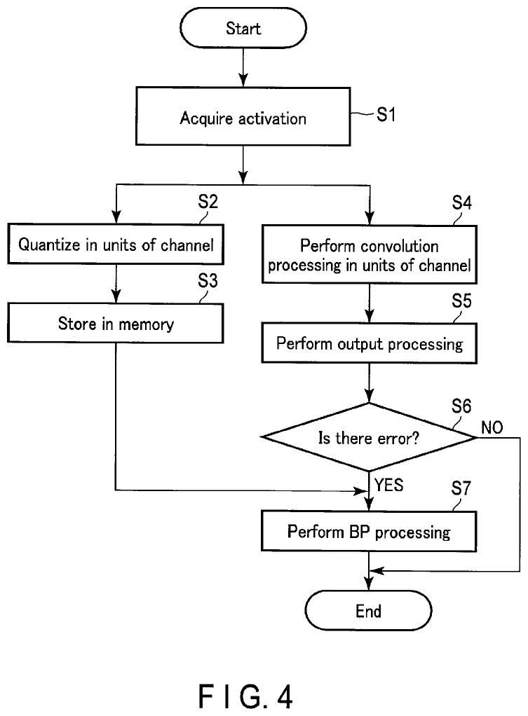

The operation of the first embodiment will be described below with reference to FIG. 3 and FIG. 4. FIG. 3 is a diagram for explaining convolution processing and quantization included in the learning processing of the CNN 20 according to the first embodiment. FIG. 4 is a flowchart for explaining a procedure of the learning process. The learning processing is performed by the learning processing unit 12 and will be described as the operation of the CNN 20.

As illustrated in FIG. 3, in the CNN 20, the CV layer (21-1, 21-2) performs convolution processing (31) using a plurality of types of weight filters 32-1 to 32-3 with respect to input X. Here, when the input X includes activations 30-1 to 30-3 of three channels CH-1 to CH-3 as in, for example, a color image, the number of channels of the weight filter 32-1 (32-2, 32-3) is also three. Specifically, the channels CH-1 to CH-3 correspond to, for example, a red image, a green image, and a blue image of a color image.

That is, the CNN 20 performs the convolution processing (31) using weight parameters (including weight W and bias B) by the weight filter 32 (32-1 to 32-3). The CNN 20 propagates the result of the convolution processing to the output layer (not illustrated) via each layer including the BN layer 22-1 or the activation layer 23-1 (forward propagation: Forward). The output layer calculates an error between the output Y including feature amounts 33-1 to 33-3 extracted by the convolution processing (31) and the correct answer label.

When there is an error (dY) between the output Y and the correct answer label, the CNN 20 performs weight parameter update processing by back propagation. Here, it is assumed that the weight parameter after the update is dZ.

As described above, in the CNN 20, the input value (input X) for each layer including the CV layer 21-1 in the intermediate layer is referred to as activation. As illustrated in FIG. 3, in the first embodiment, the activation is quantized (34) for each channel. CH (CH-1 to CH-3). Specifically, the learning processing unit 12 stores the activation quantized (34) for each channel CH in the memory 11 during the back propagation (BP processing) in the CNN 20. In the following description, the quantized (34) activation may also be referred to as quantization activation.

The procedure of the learning processing outlined as above will be described with reference to the flowchart of FIG. 4.

When the CNN 20 acquires (inputs or receives) the activation 30 (30-1 to 30-3) performed in the unit of channel CH as the input X (S1), the above-described Forward processing and BP processing (Backward processing) are performed. That is, in the Forward processing, the CV layer 21 performs the convolution processing of the activation 30 performed in the unit of channel CH by the weight filter 32 (S4). Here, in the first embodiment, in the Forward processing, the learning processing unit 12 quantizes the activation 30 in the unit of channel CH for use in the BP processing in the CNN 20 (S2). The learning processing unit 12 stores the quantization activation performed in the unit of channel CH in the memory 11 (S3).

On the other hand, the CNN 20 propagates the result of the convolution processing (S4) to the output layer via each layer including the BN layer 22 or the activation layer 23 as the Forward processing. The output layer performs output processing for calculating an error between the output Y including the feature amounts extracted by the convolution processing and the correct answer label (S5).

When there is error between the output Y and the correct answer label (YES in S6), the CNN 20 back-propagates the error to the intermediate layer (Backward), and performs the BP processing for performing the weight parameter update processing (S7). In the first embodiment, the learning processing unit 12 performs the BP processing by using the quantization activation performed in the unit of channel CH stored in the memory 11.

In the above-described learning processing, the BP processing of the first embodiment will be described by returning to FIG. 3.

As illustrated in FIG. 3, the respective activations 30-1 to 30-3 performed in units of channel CH are quantized (34) and stored in the memory 11. In the first embodiment, for example, the activation represented by an accuracy of 32 bits is quantized so as to be represented by a different number of bits of accuracy for each channel CH. For example, the activation 30-1 corresponding to the channel CH-1 is quantized into a quantization activation 35-1 in which the number of bits is represented by an accuracy of 7 bits. In addition, for example, the activation 30-2 corresponding to the channel CH-2 is quantized into a quantization activation 35-2 in which the number of bits is represented by an accuracy of 9 bits. Furthermore, the activation 30-3 corresponding to the channel CH-3 is, for example, quantized into a quantization activation 35-3 in which the number of bits is represented by an accuracy of 8 bits.

Here, as a condition of the quantization (34), a quantization width (the number of bits of the value obtained by the quantization) is a fixed value that can ensure appropriate learning accuracy in each layer. Alternatively, the quantization width may be a value depending on a variance value a after normalization processing by the BN layer 22-1 (22-2). The normalization processing is processing for calculating an average value p and a variance value a of the input X, subtracting the average value p from the input X, and dividing the result by the variance value a. Furthermore, as the condition of the quantization (34), the number of quantization bits that can ensure appropriate learning accuracy is determined by the maximum value or the minimum value of the activation 30 of each channel CH.

When the CNN 20 calculates the error dY between the output Y and the correct answer label in the output layer, the CNN 20 back-propagates the error dY (Backward) and performs the BP processing. The BP processing updates the weight parameter of each activation 30 by using the quantization activation performed in the unit of channel CH and the back-propagated error dY (update parameter dZ). For example, an update parameter 38-1-1 is calculated by performing the update processing (36) by using the quantization activation 35-1 of the channel CH-1, which is quantized with an accuracy of 7 bits, and an error 37-1. Further, an update parameter 38-2-1 is calculated by using the quantization activation 35-1 and an error 37-2, and an update parameter 38-3-1 is calculated by using the quantization activation 35-1 and an error 37-3. Similarly, the BP processing calculate an update parameter 38-1-2, 38-2-2, 38-3-2 by using the quantization activation 35-2 of the channel CH-2, which is quantized with an accuracy of 9 bits, and an error 37-1, 37-2, 37-3. Furthermore, the BP processing calculate an update parameter 38-1-3, 38-2-3, 38-3-3 by using the quantization activation 35-3 of the channel CH-3, which is quantized with an accuracy of 8 bits, and an error 37-1, 37-2, 37-3.

The CNN 20 updates the weight parameters, and repeats the convolution processing by using this update parameter (dZ) to repeatedly perform the learning processing until the error is lowered below a predetermined value, or by a predetermined number of times (epoch) of the learning processing.

As described above, according to the method of the first embodiment, in the CNN, the activation performed in units of channel in the intermediate layer is quantized, and the quantization activation is stored in the memory for use in the BP processing. That is, since the quantization activation with the reduced number of bits is stored in the memory, the memory capacity can be reduced. In this case, the number of quantization bits that can ensure appropriate accuracy can be determined in units of channel by quantizing the activation in units of channel.

Therefore, the method of the first embodiment can ensure appropriate learning accuracy as compared to the case of uniformly quantizing the activation in the CNN in the forward direction. In addition, as the quantization condition of the present embodiment, since the quantization width (the number of bits of the value obtained by the quantization) is set to a fixed value that can ensure appropriate learning accuracy in each layer, there is a high possibility that the deterioration of the learning accuracy due to the influence of the quantization width can be avoided.

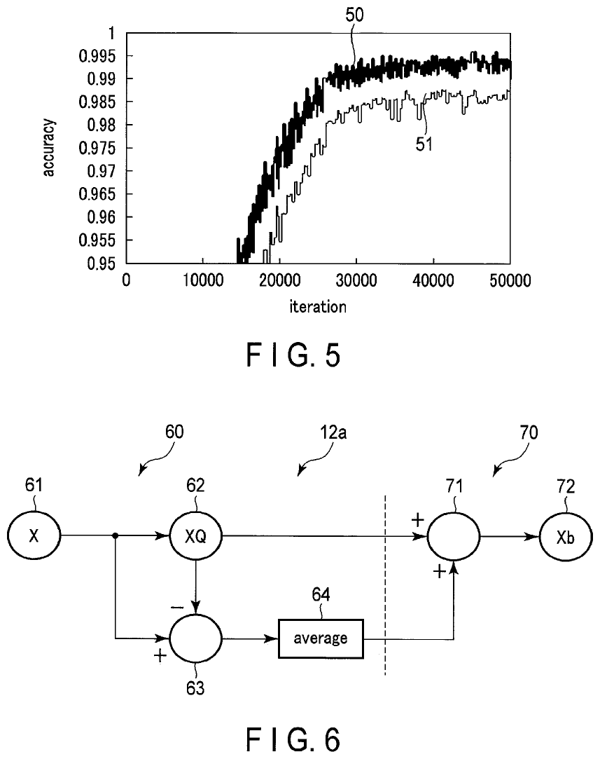

Furthermore, a comparative example in which the number of quantization bits performed in units of channel is set as, for example, 8 bits, the quantization width is quantized in a predetermined range of the variance value σ after the normalization processing for each channel, and the outside of the range is clipped out is considered. In the comparative example, the deterioration of learning accuracy due to the influence of the clip is expected. FIG. 5 is an example of comparing the learning result 50 according to the method of the present embodiment with the learning result 51 according to the comparative method.

Here, in FIG. 5, a horizontal axis represents, for example, the number of iterations of the learning processing in which 80 classes are extracted from an image data set of 1,000 classes of ImageNet (image data set prepared on the Internet as a learning sample), and a vertical axis represents learning accuracy. As illustrated in FIG. 5, the method of the first embodiment can ensure relatively high learning accuracy as compared to the comparative method.

### Second Embodiment

FIG. 6 is a block diagram illustrating an example of a schematic configuration of a learning processing unit 12a according to a second embodiment. Note that the configuration of the system of the second embodiment is the same as the system of the first embodiment described above (see FIG. 1 and FIG. 2), except for the intermediate configuration of the learning processing unit 12a illustrated in FIG. 6.

As illustrated in FIG. 6, the learning processing unit 12a of the second embodiment includes a quantization unit 60 that quantizes the activation in units of channel and stores the quantization activation performed in the unit of channel in the memory 11 during the above-described forward processing. Furthermore, the learning processing unit 12a includes a compensation processing unit 70 that compensates for the quantization activation performed in the unit of channel during the above-described backward processing (BP processing).

The quantization unit 60 performs quantization processing (62) in the unit of channel for use in the BP processing with respect to the activation (61) that is the input X of, for example, three channels CH-1 to CH-3 as described above. The quantization unit 60 acquires quantization activation (XQ) performed in the unit of channel by the quantization processing (62) and stores the acquired quantization activation (XQ) in the memory 11.

In the second embodiment, the quantization unit 60 performs the calculation processing (63) of calculating a difference between the quantization activation (XQ) and the activation (61) before quantization. Furthermore, the quantization unit 60 performs the calculation processing (64) of calculating an average value (difference average value) performed in the unit of channel or in the unit of the mini batch of the difference value calculated by the calculation processing (63). The quantization unit 60 stores the difference average value calculated by the calculation processing (64) in the memory 11 together with the quantization activation (XQ).

Meanwhile, the compensation processing unit 70 adds the quantization activation (XQ) and the difference average value stored in the memory 11 and performs the compensation processing (71) of compensating for the number of bits lost due to quantization at the time of the Backward processing. That is, the compensation processing unit 70 generates activation (72) after compensation by the compensation processing (71) as the input (Xb) performed in units of channel CH for use in the BP processing.

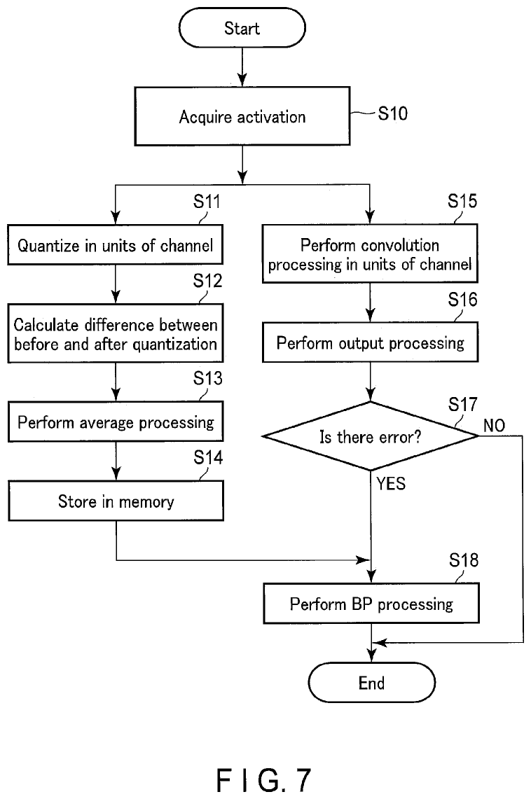

Next, the procedure of the learning processing according to the second embodiment will be described with reference to the flowchart of FIG. 7 and FIGS. 2 and 6.

When the activation (61) performed in the unit of channel CH is acquired (input or received) as the input X (S10), the CNN 20a (the same configuration as the CNN 20 illustrated in FIG. 2) of the second embodiment performs the above-described Forward processing and Backward processing (BP processing). That is, in the Forward processing, the CV layer 21 performs the convolution processing of the activation (61) performed in units of channel CH by the weight filter 32 (S15).

Here, in the second embodiment, the quantization unit 60 included in the learning processing unit 12a quantizes the activation (61) in units of channel CH for use in the BP processing (S11). Furthermore, the quantization unit 60 calculates the difference between the quantization activation (XQ) after quantization and the activation (61) before quantization (S12). The quantization unit 60 performs the average processing for calculating an average value (difference average value performed in units of channel or in units of mini batch) of the difference values before and after quantization (S13). The quantization unit 60 stores the difference average value in the memory 11 together with the quantization activation (XQ) (S14).

Meanwhile, the CNN 20a propagates the result of the convolution processing (S15) to the output layer via each layer including the BN layer 22 or the activation layer 23 as the Forward processing. The output layer performs the output processing for calculating an error between the output Y including the feature amounts extracted by the convolution processing and the correct answer label (S16). When there is error between the output Y and the correct answer label (YES in S17), the CNN 20a back-propagates the error to the intermediate layer (Backward), and performs the BP processing for performing the weight parameter update processing (S18).

Here, in the second embodiment, as the previous stage of performing the BP processing, the compensation processing unit 70 included in the learning processing unit 12a performs the compensation processing on the quantization activation (XQ) stored in the memory 11 by using the difference average value, and outputs activation (72) after compensation. Specifically, the compensation processing unit 70 adds the quantization activation (XQ) and the difference average value stored in the memory 11 as described above, and compensates for the number of bits lost due to quantization.

In the second embodiment, the learning processing unit 12a performs the BP processing for updating weight parameters by using the activation (72) performed in the unit of channel CH after compensation. Note that, in the second embodiment as well, the same BP processing as that of the first embodiment is performed as described above, except that the activation (72) performed in units of channel CH after compensation is used. The condition of the quantization processing (62) by the quantization unit 60 is also the same as in the first embodiment.

As described above, in the method of the second embodiment as well, the activation performed in units of channel in the intermediate layer is quantized and stored in the memory for use in the BP processing. Therefore, with respect to the activation before quantization, quantization activation in which the number of bits is reduced can be stored in the memory, and therefore, the memory capacity can be reduced.

On the other hand, since the information corresponding to the bits lower than the LSB (least significant bit) of the quantized results is discarded from the bit strings before the quantization by the quantization process, therefore the learning accuracy may be degraded. As a results, when the number of quantization bits is set in units of channel, the number of bits to be reduced may be limited so as to ensure a predetermined learning accuracy. In the second embodiment, as described above, the compensation processing unit 70 makes it possible to compensate for the number of bits lost due to the quantization with respect to the quantization activation. Therefore, in the case of quantizing the activation in the unit of channel, even if the number of bits to be reduced is relatively increased, it is possible to ensure a predetermined learning accuracy.

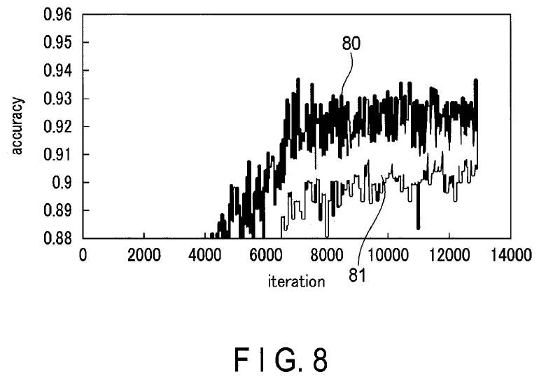

FIG. 8 illustrates an example of comparing the learning result 80 according to the method of the second embodiment with the learning result 81 according to the method without compensation processing. Here, in FIG. 8, a horizontal axis represents, for example, the number of iterations of the learning processing in which 40 classes are extracted from an image data set of 1,000 classes of ImageNet (image data set prepared on the Internet as a learning sample), and a vertical axis represents learning accuracy when quantization is performed with, for example, 3 bits. As illustrated in FIG. 8, the method of the present embodiment can ensure relatively high learning accuracy as compared to the method without compensation processing.

### Modification

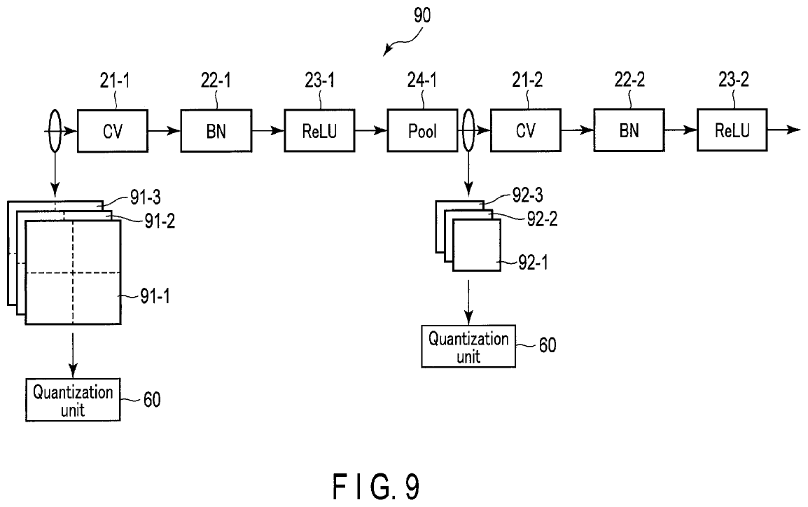

FIG. 9 is a diagram for explaining a configuration of a modification of the second embodiment. As illustrated in FIG. 9, a CNN 90 of the present modification is an example including a pooling layer 24 with respect to the example of the CNN 20 as illustrated in FIG. 2. The pooling layer 24 performs processing for reducing feature amounts output from an activation layer 23. That is, when a size (here, an image size) of the feature amount for each channel, which is the output Y from the activation layer 23, is 14×14 (pixels), the pooling layer 24 outputs the feature amount (92-1 to 92-3) reduced to a size of 7×7 (pixels).

The CNN 90 is configured to reduce the size of the feature amount of each layer according to the progress of the Forward processing. Here, in the case in which the size of the feature amount is relatively large, when the difference average value is calculated in the average processing (64) in the quantization unit 60, it is confirmed that the so-called locality of activation (that is, feature in the unit of one image) is lost from the difference average value.

Therefore, in the present modification, when the quantization unit 60 calculates the average value of the difference values before and after quantization, the activation (61) before quantization is divided into areas having a specific unit of size (H size or W size). The H size means a small image size corresponding to a weight filter. In addition, the W size corresponds to an image size of a gray scale.

Specifically, the quantization unit 60 divides the feature amount 91 (91-1 to 91-3) having, for example, a 14×14 size into areas each having a 7×7 size, and calculates the average value of the difference value between the activation (61) before quantization and the quantization activation (XQ) for each divided area. The quantization unit 60 stores the difference average value for each area in the memory 11. Therefore, in the case of compensating for the quantization activation (XQ) with respect to the feature amount 91 in which the size of the feature amount is relatively large, for example, the 14×14 size, the difference average value with each area having the 7×7 size can be used. Therefore, in the case of using the quantization activation (XQ) of the feature amount having a large size at the time of the BP processing, it is possible to ensure the locality of the quantization activation (XQ) by performing the compensation processing by using the difference average value.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of a learning processing of a deep layer neural network having an intermediate layer including a convolution layer, in an information processing using a processor and a memory used for an operation of the processor, the method comprising:
acquiring a second value represented by the second number of bits obtained by reducing the first number of bits representing a first value being an input value in units of channel in the intermediate layer of the deep layer neural network;
storing the acquired second value of the second number of bits into the memory; and
performing a back propagation using the second value stored in the memory instead of the first value.

2. The method of claim 1, wherein the acquiring the second value of the second number of bits comprises setting the number of bits capable of representing the second value with a predetermined learning accuracy as the second number of bits in units of channel, based on a maximum value or a minimum value of the first value in units of channel to reduce the first number of bits in units of channel.

3. The method of claim 1, wherein the acquiring the second value of the second number of bits comprises setting the second number of bits being a fixed value based on a predetermined learning accuracy in each layer included in the intermediate layer as the number of bits of a value obtained by a quantization of the first value.

4. The method of claim 3, wherein the acquiring the second value of the second number of bits comprises quantizing respective activations in units of channel in the intermediate layer based on a predetermined number of quantization bits, and
the storing into the memory comprises storing a quantization activation represented by the predetermined number of quantization bits into the memory.

5. The method of claim 4, wherein the acquiring the second value of the second number of bits comprises setting the number of quantization bits as the number of the second bits in units of channel by the predetermined learning accuracy based on a maximum value or a minimum value of the activation performed in units of channel.

6. The method of claim 4, wherein the acquiring the second value of the second number of bits comprises
when quantizing the activation in units of channel, setting the fixed value based on the predetermined learning accuracy in each layer included in the intermediate layer as the number of bits of the value obtained by the quantization.

7. An information processing apparatus for a learning processing of a deep layer neural network having an intermediate layer including a convolution layer, the apparatus comprising:
a processor; and
a memory configured to be used in processing of computation of the processor,
wherein the processor is configured to:
acquire a second value represented by the second number of bits obtained by reducing the first number of bits representing a first value being an input value in units of channel in the intermediate layer of the deep layer neural network;
store the acquired second value of the second number of bits into the memory; and
perform a back propagation using the stored second value instead of the first value.

8. The apparatus of claim 7, wherein the processor is further configured to set the number of bits capable of representing the second value with a predetermined learning accuracy as the second number of bits in units of channel, based on a maximum value or a minimum value of the first value in units of channel, when acquiring the second value of the second number of bits.

9. The apparatus of claim 7, wherein the processor is further configured to set the second number of bits being a fixed value based on a predetermined learning accuracy in each layer included in the intermediate layer as the number of bits of a value obtained by a quantization of the first value to reduce the first number of bit in units of channel when acquiring the second value of the second number of bits.

10. A method of a learning processing of a deep layer neural network having an intermediate layer including a convolution layer, in an information processing using a processor and a memory used for an operation of the processor, the method comprising:
acquiring a second value represented by the second number of bits obtained by reducing the first number of bits representing a first value being an input value in units of channel in the intermediate layer of the deep layer neural network;
calculating a first difference average value between the acquired second value of the second number of bits and the first value of the first number of bits; and
storing the acquired second value and the calculated first difference average value into the memory.

11. The method of claim 10, further comprising performing a back propagation including a compensation processing using the second value and the first difference average value stored in the memory.

12. The method of claim 11, further comprising performing a back propagation in units of channel by using an input value in units of channel compensated by the compensation processing.

13. The method of claim 10, wherein the calculating includes:
dividing the first value into predetermined areas; and
calculating a second difference average value between a value of each of the divided areas and the second value.

14. The method of claim 13, further comprising storing the second value and the calculated second difference average value into the memory.

15. An information processing apparatus for a learning processing of a deep layer neural network having an intermediate layer including a convolution layer, the apparatus comprising:
a processor; and
a memory configured to be used in processing of computation of the processor,
wherein the processor is configured to:
acquire a second value represented by the second number of bits obtained by reducing the first number of bits representing a first value being an input value in units of channel in the intermediate layer of the deep layer neural network;
calculate a first difference average value between the acquired second value of the second number of bits and the first value of the first number of bits; and
store the acquired second value and the calculated first difference average value into the memory.

16. The apparatus of claim 15, wherein the processor is further configured to perform a back propagation including a compensation processing using the second value and the first difference average value stored in the memory.

17. The apparatus of claim 16, wherein the processor is further configured to perform a back propagation in units of channel by using an input value in units of channel compensated by the compensation processing.

18. The apparatus of claim 15, wherein the processor is further configured to:
divide the first value stored in the memory into predetermined areas; and
calculate a second difference average value between a value of each of the divided areas and the second value.

19. The apparatus of claim 18, wherein the processor is further configured to store the second value and the calculated second difference average value into the memory.
